(19) United States
(12) Patent Application Publication
(10) Pub. No.: US 2015/0037470 A1
(43) Pub. Date: Feb. 5, 2015

(54) Capsule, Device and Method for Preparing a Beverage by Extraction

(71) Applicants: Sander Gordon Zweed, Bussum (NL); Jan Andreae, Blaricum (NL); Antonio Giuseppe Perra, Bergen (NL); Mark Eric Anton Arthur Klep, Andel (NL)

(72) Inventors: Sander Gordon Zweed, Bussum (NL); Jan Andreae, Blaricum (NL); Antonio Giuseppe Perra, Bergen (NL); Mark Eric Anton Arthur Klep, Andel (NL)

(73) Assignee: BISERKON HOLDINGS LTD., Nicosia (CY)

(21) Appl. No.: 13/805,189

(22) PCT Filed: Jun. 20, 2011
(86) PCT No.: PCT/NL2011/050442

§ 371 Date: Feb. 12, 2014

(30) Foreign Application Priority Data
Jun. 18, 2010 (NL) 2004921
Aug. 5, 2010 (NL) 2005196
Oct. 7, 2010 (NL) 2005483
Oct. 21, 2010 (NL) 2005559
Nov. 5, 2010 (NL) 2005642
May 10, 2011 (NL) 2006758
May 12, 2011 (NL) 2006772

(51) Int. Cl. B65D 85/804; A23F 5/26; A47J 31/40

(52) U.S. Cl. CPC B65D 85/8043; A47J 31/407; A23F 5/262
USPC 426/115; 99/295; 426/431

(57) ABSTRACT

The invention relates to a capsule for use in a device for preparing beverages. The invention also relates to an assembly of such a capsule and a device for preparing beverages. The invention further relates to a method for preparing beverages by making use of such an assembly.

The invention relates to a capsule for use in a device for preparing beverages. The invention also relates to an assembly of such a capsule and a device for preparing beverages. In addition, the invention relates to a perforation structure evidently intended for use in such a capsule according to the invention. The invention also relates to the use of such a capsule in a device for preparing beverages. The invention further relates to a method for preparing beverages by making use of such an assembly.

Diverse capsules for use in a device for preparing beverages are known in the prior art. A known capsule as described for instance in EP 0512468 comprises a housing provided with a perforable supply side for injecting a liquid into the housing and with a discharge side located at a distance from the supply side and provided with an opening for the purpose of discharging liquid injected into the housing, a quantity of substance for extraction received in the housing, such as ground coffee beans, and a pierceable foil connected to the housing and sealing the opening located on the discharge side. This known capsule can be placed in a device for preparing a beverage. The capsule is placed for this purpose in a receiving space of a capsule holder of the device. The capsule is clampingly supported here in the receiving space by a support and a clamp. The supply side of a housing of the capsule is perforated by subsequently moving a liquid injector through the housing of the capsule, and a relatively hot liquid, in particular water, can be introduced into the housing under a relatively high pressure, generally of between 15 and 20 bar. The foil is perforated by moving a perforation plate forming part of the capsule holder and the capsule toward each other and the extracted liquid flows via the perforation plate into a beverage container. A drawback of using this known capsule and device for preparing a beverage while making use of such a capsule is that the device requires relatively high maintenance. There is therefore a need for a device requiring less maintenance.

An object of the invention is to provide for the above stated need.

The invention provides for this purpose a capsule of the type stated in the preamble, comprising: a housing at least partially filled with a substance to be extracted and/or dissolved, such as ground coffee, wherein the housing is provided with a supply side for guiding a liquid such as water into the capsule, and with a discharge side located a distance from the supply side for discharging liquid provided with extract and/or dissolved substance and guided through the capsule, wherein at least a part of the discharge side of the housing is initially sealed by a perforable foil; a laterally protruding engaging edge connected to the housing to enable clamping of the capsule in a device for preparing beverages; and a perforation structure coupled to the engaging edge and/or the housing and provided with at least one perforation element facing toward the foil, which perforation structure is positioned substantially on a side of the foil remote from the housing, which perforation structure is displaceable from a first position, in which the foil is substantially intact, to a second position in which the at least one perforation element perforates the foil, whereby discharge of liquid from the capsule is possible. By providing the capsule with a perforation structure displaceable relative to the housing for the purpose of perforating the foil, this displacement being realized by having the capsule clamped by a capsule holder of a device for preparing beverages, a conventional perforation plate forming part of the device is no longer required. The advantage hereof is that the prepared beverage need no longer be pressed through the conventional perforation plate of the device, but can optionally be delivered directly from the capsule to a drinking cup. This can drastically reduce the beverage residue left behind in the device, this being advantageous from a hygiene viewpoint and reducing the required maintenance on the device. It is moreover possible in this way to prevent, or at least counter, beverage pressed out of the capsule mixing with beverage residues coming from one or more already used capsules and already present in the device, whereby the taste of the beverage to be prepared can be guaranteed as fully as possible. The perforation structure will generally be provided with one or more throughflow channels or throughfeed openings extending between a side of the perforation structure facing toward the foil and a side of the perforation structure remote from the foil. The particular advantage here is that the number of throughflow channels to be applied and the dimensioning of these throughflow channels can be wholly adapted to the nature of the beverage to be prepared, wherein the intensity of the aeration, the extent of the pressure buildup and the swirling of the beverage pressed out of the capsule can be regulated, which can considerably enhance the taste sensation during consumption of the beverage. Because the foil will be perforated by the generally pointed perforation elements and will be pressed during use against the perforation structure, a filtering action will be realized, whereby solid constituents such as coffee dregs can be kept in the housing. The supply side will otherwise generally take a closed form initially, wherein the supply side will be perforated in the device during use. It is also possible to envisage the supply side already being pre-perforated during the production process, whereby further perforation in the device can be dispensed with. The drawback hereof is however that the capsule generally has to be packaged in order to enable a sufficiently long shelf-life of the substance, and therefore of the capsule. Initial, substantially hermetic sealing of the capsule is generally recommended, wherein the capsule can optionally be filled with an inert gas, such as nitrogen or carbon dioxide, in order to further increase the shelf-life of the substance. The result hereof is that a slight overpressure of several hundred millibar will generally be present in the capsule. This overpressure can possibly increase to some extent if coffee powder, which naturally generates a limited amount of gas, is received in the capsule.

The housing can be manufactured from diverse materials, including an aluminium and/or plastic, in particular polypropylene (PP). When a plastic housing is applied, the housing will generally be manufactured from a laminate of a plurality of plastic layers, such as PP and ethylene vinyl alcohol (EVOH). When an aluminium housing is applied, it is generally also usual to laminate the aluminium with one or more additional layers, including a protective lacquer coating in order to avoid direct contact of aluminium with the beverage to be prepared, and including for instance a PP layer to enable realization of an (ultrasonic) welded connection to the foil. The foil generally also comprises aluminium which is optionally provided on one or two sides with a PP layer in order to facilitate one or two-sided adhesion of the foil. It is also possible to envisage the foil comprising aluminium oxide (ALOX), optionally laminated with plastic such as polyethylene terephthalate (PET), whereby an exceptionally thin foil can be obtained with a thickness in the order of magnitude of several microns. The foil is generally connected by means of welding and/or adhesion to the engaging edge, in particular to a flange forming part of the housing.

The perforation structure usually takes a plate-like form in order to limit the occupied volume. The housing and the perforation structure are in general initially positioned (in the first position) on either side of a plane defined by the foil. In this first position the perforation structure will generally be located substantially outside a volume enclosed by the housing. The perforation structure can take a flexible and deformable form here, whereby the perforation structure can be displaced (clicked) from the first position (first state) to the second position (second state) by deforming at least a part of the perforation structure. It is possible here to envisage the perforation structure remaining permanently coupled, in particular remaining connected, to the engaging edge and/or the housing, for instance by applying one or more film hinges. A suitable material for such a flexible perforation structure is plastic, such as for instance PP or polyethylene (PE).

In an alternative embodiment the perforation structure is initially connected in the first position via at least one breakable connection to the engaging edge, wherein the perforation structure is displaceable to the second position by breaking the connection between the perforation structure and the engaging edge. In this embodiment the perforation structure will generally take a substantially rigid form. A suitable material for manufacturing such a substantially rigid perforation structure is for instance PP. The perforation structure is preferably initially positioned such that the connection between the engaging edge and the perforation structure will be broken during clamping of the capsule in the device. It is optionally also possible to envisage the connection being broken by the user him/herself by pushing the perforation structure in the direction of the foil. Instead of using a breakable connection it is also possible to envisage providing the engaging edge and/or the housing with a guide for co-action with the perforation structure, whereby the perforation structure can in fact be shifted from the first position to the second position.

It is generally advantageous for the perforation structure to be substantially or at least partially enclosed by the housing in the second position. In the second position the perforation structure thus lies substantially here within a space enclosed by the housing. The advantage hereof is that the dimensioning of the housing need not be adapted to the standard dimensioning, this being advantageous from an economic point of view. It is advantageous here for the perforation structure to be pressed with clamping fit into the housing so that the peripheral wall of the perforation structure, preferably via a foil part, engages under bias on an inner wall of the housing, whereby a relatively good edge sealing can be realized. This reliable edge sealing forces liquid pressed through the capsule to exit via actual discharge openings which are generally arranged in the perforation structure.

When the perforation structure is connected releasably to the engaging edge and/or the housing, it is advantageous for the edge periphery of the perforation structure to be connected via one and preferably a plurality of connecting elements to the engaging edge. It is particularly advantageous here for the thickness of the connecting element to decrease in the direction of the perforation structure, whereby the connecting elements will break away from the perforation structure sooner than from the engaging edge, which facilitates displacement of the perforation structure from the first position to the second position.

The engaging edge generally comprises at least one flange connected integrally to the housing. It is also possible to envisage the flange being chemically and/or mechanically connected to an inner side and/or outer side of the housing. The engaging edge will usually be constructed in laminated manner from at least one flange connected to the housing and a support structure coupled to the flange, the support structure being adapted for co-action with the perforation structure, and wherein the support structure is particularly adapted to initially hold the perforation structure via the at least one breakable connection. The support structure will generally take a substantially annular form here, because the flange will usually have the same shape. It is possible here to envisage the support structure at least partially enclosing, and even being able to clamp, the flange. The support structure can be constructed from a plurality of parts which are mutually connected during the production process, for instance by means of welding or adhesion.

The perforation structure and the support structure are preferably manufactured at least partially from the same material, such as polypropylene. The support structure is preferably constructed here from a lower part initially connected directly to the perforation plate and an upper part connected to the lower part, wherein the lower part and the upper part are at least positioned at least partially on either side of the flange connected to the housing or forming part of the housing, whereby the flange is at least partially covered on an underside and an upper side by the support structure. The upper part of the support structure can be connected integrally to the lower part of the support structure, wherein the support structure is even manufactured from one material, in particular plastic, preferably polypropylene. The lower part of the support structure will however generally be adapted to initially hold (support) the perforation structure and the upper part of the support structure will generally be adapted as sealing element. It is therefore generally advantageous to select the material properties of the upper part of the support structure such that a reliable sealing of the capsule in the capsule holder can be realized. These selected material properties are preferably also such that a reliable connection can be realized between the lower part of the support structure and the upper part of the support structure. The upper part of the support structure is preferably manufactured for this purpose from a composition comprising polypropylene and an elastomeric copolymer of units of ethylene and units of an V-olefin, such as ethylene, propylene or 1-butene. The upper part of the support structure is preferably manufactured at least partially from a composition comprising 20-50% by weight crystalline polypropylene and 50-80% by weight elastomeric ethylene copolymer. Further details of the thermoplastic polypropylene-based elastomer are described in EP 0770106 and EP 0472946. Such thermoplastic polyolefins are commercially available under the brand names Hifax®, in particular Hifax® 7334 XEP, Adflex®, in particular Adflex® X500F, and Softell®. It is otherwise also possible to envisage providing an outer surface of the capsule with at least one other type of sealing element for sealing the capsule in the device.

In an advantageous embodiment the perforation structure is provided with a plurality of throughflow channels for discharge of liquid, the throughflow channels extending from a side of the perforation structure facing toward the foil to a side of the perforation structure remote from the foil. The perforation structure is generally also provided with a plurality of perforation elements. It is possible here to envisage at least a number of throughflow channels being located at a distance from the perforation elements. It is however also possible to envisage, and even advantageous, for at least one perforation element to be provided with one or more throughflow channels. It is found particularly advantageous in practice to apply a conical perforation element through which extend three throughflow channels which debouch in the cone wall, whereby blocking of the throughflow channels by perforated foil parts can be prevented.

For the purpose of being able to prevent blocking of an outer end of a throughflow channel by the device it is advantageous for a side of the perforation structure remote from the foil to be provided with at least one surface groove, the surface groove connecting to at least one outer end of at least one throughflow channel. It is further possible to envisage a side of the perforation structure remote from the foil being provided with a plurality of surface grooves, the surface grooves connecting the outer ends of the throughflow channels to each other. The surface grooves can connect to each other and intersect each other and in this way form a network.

The perforation elements must be sufficiently sharp to be able to perforate the foil. It is therefore advantageous that at least a number of perforation elements take a pointed, in particular pyramid-shaped and/or cone-shaped form. A cone-shaped (conical) shape is generally recommended above a pyramid-shaped embodiment, since the conical embodiment has a periphery varying less pronouncedly as seen in the height of the perforation elements, whereby the foil will tear and/or deform more gradually and therefore more easily.

An edge part of the perforation structure facing toward the foil is generally provided with one or more perforation elements for realizing an edge perforation in the foil. The perforation element can here form a cutting edge which can extend over the whole or partial edge part of the perforation structure. In addition, it is possible to envisage application of more centrally positioned perforation elements. The peripherally oriented perforation elements are optionally positioned closer to the foil in the first position than centrally oriented perforation elements, wherein the peripheral perforation elements do in fact protrude more than the more central perforation elements. It is however also possible to envisage all perforation elements protruding equally far, wherein the outer ends define a (perforation) plane relative to each other. In order to be able to guarantee a reliable perforation, it is generally advantageous that in the first position the foil engages under bias on at least one perforation element. A subsequent small displacement of the perforation structure in the direction of the foil will then result relatively quickly in perforation of the foil. This perforation can otherwise be complete, i.e. perforation of the foil takes place only by displacement of the perforation structure in the direction of the foil (single-stage perforation). It is also possible to envisage the perforation being partial as a result of displacement of the perforation structure, and further perforation of the foil taking place during pressing of liquid through the capsule (two-stage perforation).

In an advantageous embodiment of the capsule a side of the perforation structure remote from the foil is provided with an upright sealing edge which protrudes in a direction away from the foil. This upright sealing edge provides on the one hand for an improved connection of the capsule to the device, and thereby for an improved sealing. The application of the upright sealing edge moreover makes the perforation structure stackable (nestable) with another perforation structure, this being particularly advantageous during the production process.

It is also advantageous for a side of the perforation structure remote from the foil to be provided with a chamfered peripheral edge. Application of such a chamfered peripheral edge generally facilitates positioning of the capsule in the capsule holder as well as closing of the capsule holder.

The invention also relates to an assembly of a capsule according to the invention and a device for preparing beverages, which device comprises a capsule holder for receiving the capsule. The capsule holder here preferably comprises a plurality of holder parts which are mutually displaceable between an opened state, in which the capsule can be placed in the capsule holder, and a closed state in which the engaging edge of the capsule is clamped by the holder parts and the perforation structure is uncoupled from the engaging edge and is pressed at least partially into the housing while perforating the foil.

The invention further relates to the use of a capsule according to the invention in a device for preparing beverages.

In addition, the invention relates to a perforation structure evidently intended for use in a capsule according to the invention. The perforation structure will generally be coupled (releasably) here to a support structure via one or more breakable connecting elements, wherein the assembly of perforation structure, connecting elements and at least a (lower) part of the support structure can be manufactured from one integral whole.

The invention moreover relates to a method for preparing a beverage by making use of an assembly according to the invention, comprising of: A) placing a capsule in at least a part of an opened capsule holder, B) closing the capsule holder with clamping of the engaging edge of the capsule, wherein during step B) the perforation structure of the capsule is displaced from a first position, in which the foil is substantially intact, to a second position in which the at least one perforation element of the perforation structure perforates the foil, whereby discharge of liquid from the capsule is possible, C) pressing liquid, in particular water, into the capsule via the supply side of the capsule, and D) discharging via the perforated foil liquid guided through the capsule. During step B the supply side is generally also perforated by perforation means forming part of the capsule holder.

The invention will be elucidated on the basis of non-limitative exemplary embodiments shown in the following figures. Herein:

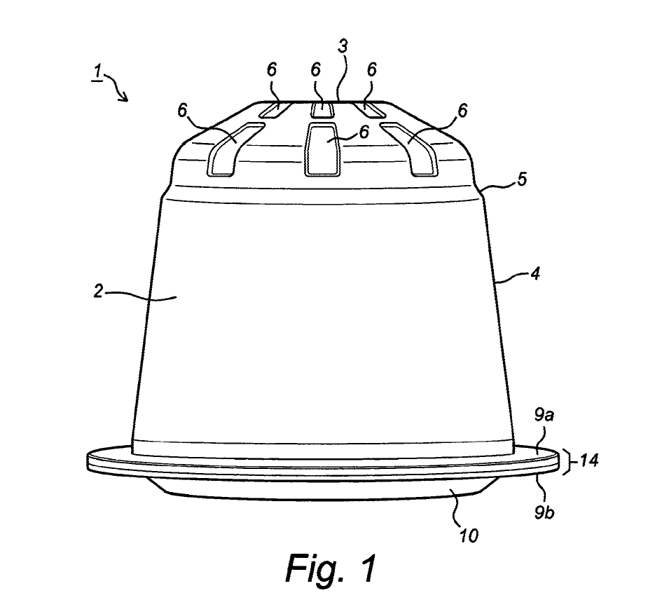

FIGS. 1-6 show different views of a first embodiment of a capsule according to the invention;

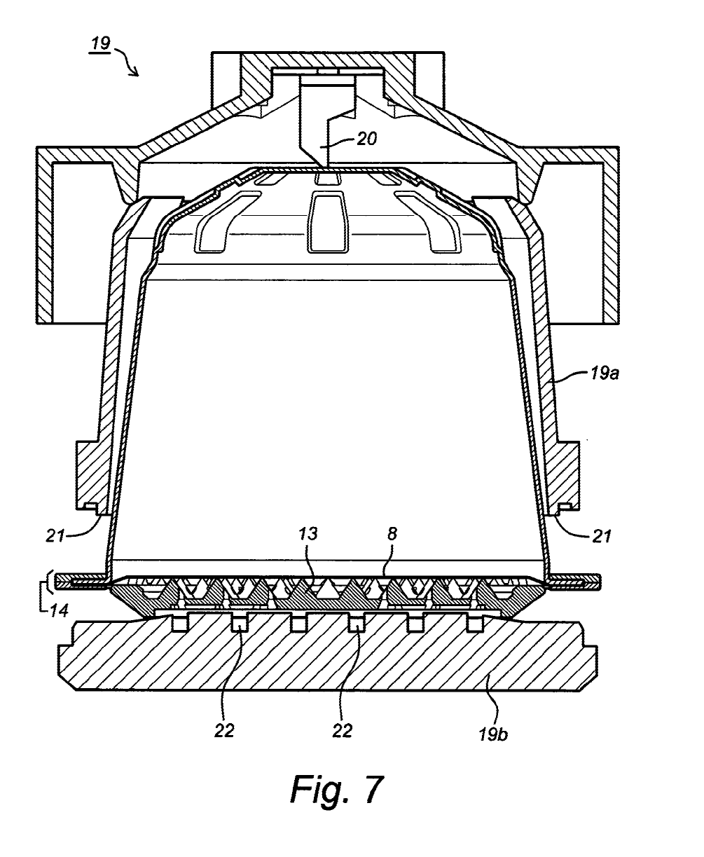

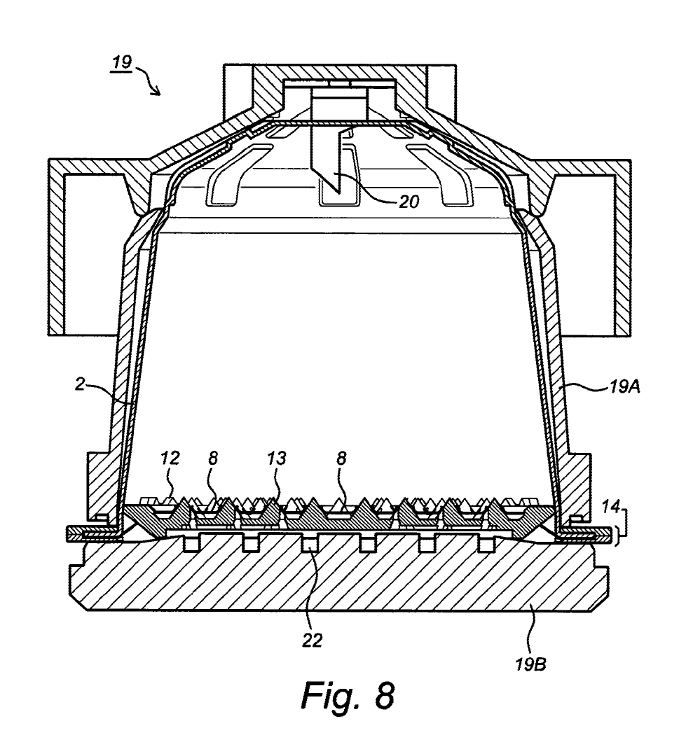

FIGS. 7 and 8 show cross-sections of a capsule according to FIGS. 1-6 in a capsule holder of a device for preparing beverages;

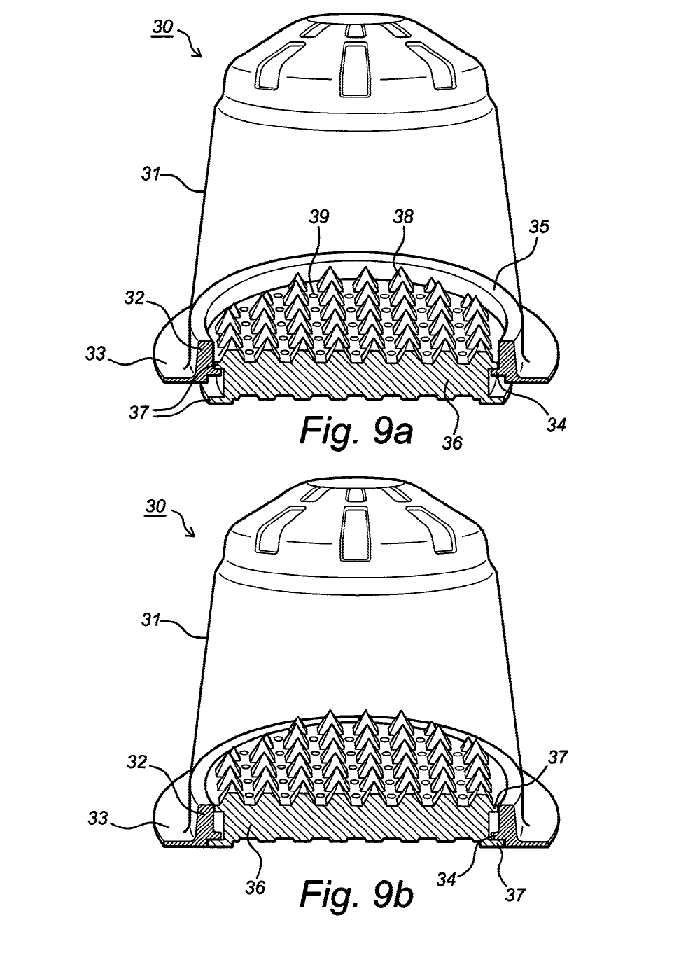

FIGS. 9a and 9b show cross sections of a second embodiment of the capsule according to the invention;

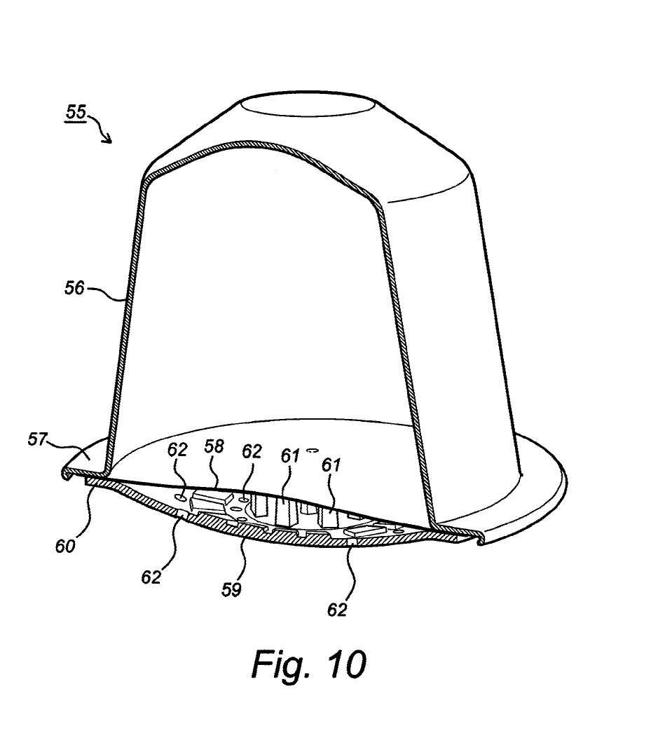

FIG. 10 is a cut-away perspective view of another capsule according to the invention;

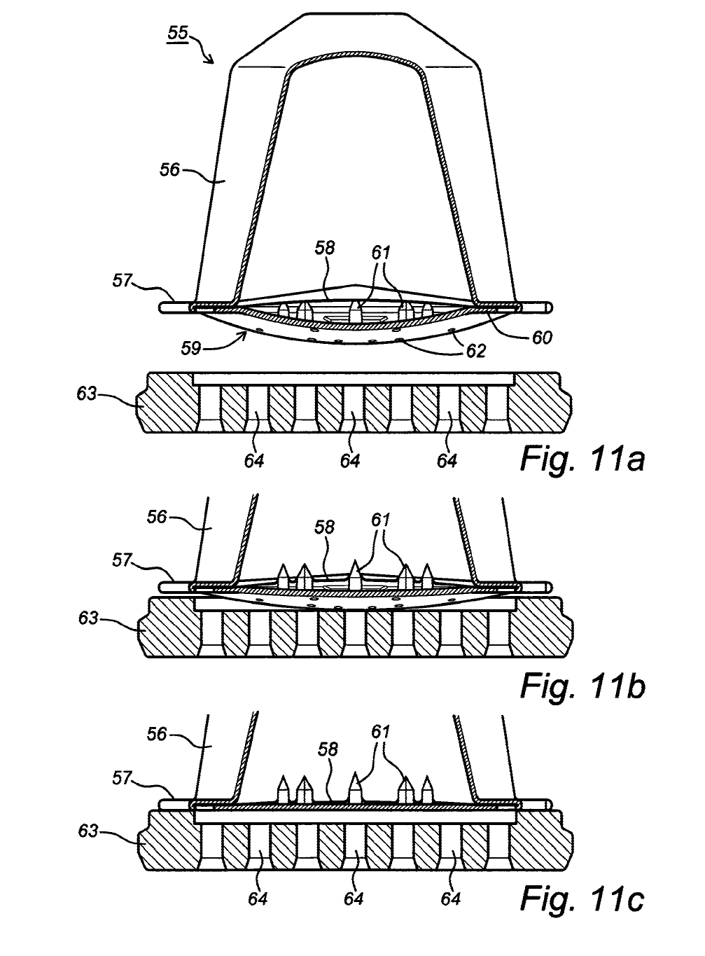

FIGS. 11a-11c show different cut-away views of the operation of the capsule according to FIG. 10; and

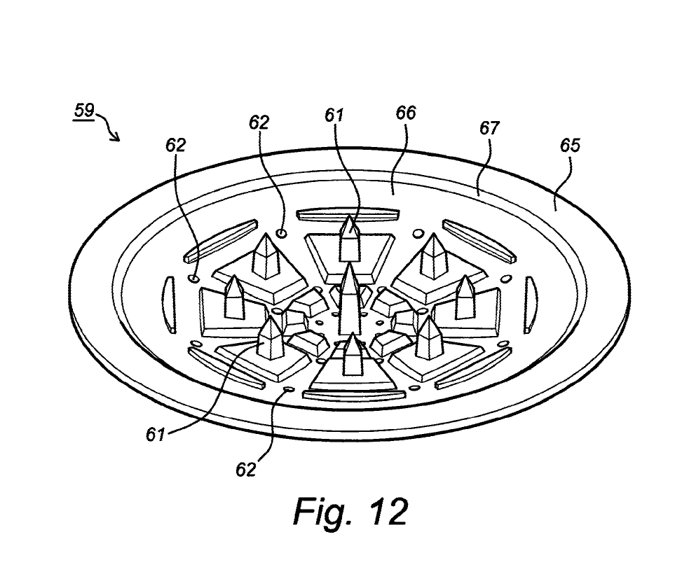

FIG. 12 is a detailed perspective view of the piercing element for use in the capsule according to FIG. 10.

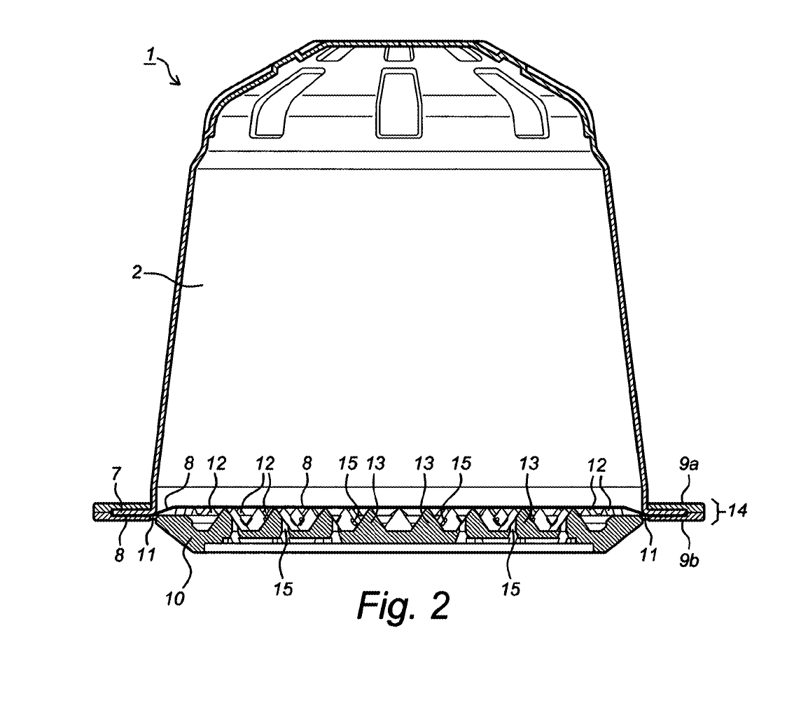

FIG. 1 shows a perspective view and FIG. 2 shows a cross-section of a first embodiment of a capsule 1 according to the invention. Capsule 1 comprises for this purpose a substantially frustoconical (truncated conical) housing 2 at least partially filled with a substance to be extracted and/or dissolved, such as ground coffee, tea, cocoa, milk powder and so on. Housing 2 comprises a perforable upper wall 3 which forms a supply side of capsule 1. The upper wall will be perforated in a capsule holder of a device for preparing beverages, after which water, in practice generally a mixture of water and air, is pressed into capsule 1 at a pressure of between 1 and 20 bar. Housing 2 also comprises a peripheral wall 4 which is integrally connected to upper wall 3 and which tapers to some extent in the direction of upper wall 3, wherein in the shown situation peripheral wall 4 encloses an angle with the vertical lying between 5° and 7°, this angle of inclination corresponding to the complementary angle of inclination of a number of capsule holders available on the market, whereby the volume of housing 2 can be maximized. Peripheral wall 4 is provided with a ridge 5 to enable better fitting of capsule 1 on many of the known capsule holders. Housing 2 further comprises a plurality of strengthening elements 6 arranged recessed into upper wall 3 and/or peripheral wall 4. Strengthening elements 6 resist deformation of housing 2 as much as possible during use. In addition, housing 2 comprises a flange 7 which is integrally connected to the peripheral wall (see FIG. 2) and which as such forms part of an engaging edge 14 of capsule 1, this engaging edge 14 being adapted to allow clamping of capsule 1 by the capsule holder. An inner edge of flange 7 does in fact define (a part of) the discharge side of capsule 1, this discharge side being initially sealed substantially medium-tightly by a foil 8 connected to flange 7. The connection between flange 7 and foil 8 is preferably realized by means of (ultrasonic) heat welding, whereby a relatively reliable connection can be realized between flange 7 and foil 8. It is advantageous here for the contact surfaces for fusing together to be manufactured from the same material, such as PP. Flange 7 is clamped by and/or enclosed by and/or connected to a support structure 9 for a plate-like perforation structure 10. In this exemplary embodiment support structure 9 here has a modular construction of an upper part 9a and a lower part 9b connected, preferably welded, to upper part 9a. Upper part 9a of support structure 9 is in principle adapted to seal capsule 1 in the capsule holder, while lower part 9b of support structure 9 is in principle adapted to initially hold perforation structure 10. Upper part 9a and lower part 9b can optionally be connected as separate elements to flange 7. Perforation structure 10 is connected by means of a plurality of breakable connecting elements 11 to support structure 9. As shown, housing 2 and perforation structure 10 are positioned on opposite sides of foil 8. In this exemplary embodiment perforation structure 10 comprises a plurality of peripherally oriented (‘peripheral’) perforation elements 12 and a plurality of more centrally oriented (‘central’) perforation elements 13. All perforation elements 12, 13 have a pointed outer end directed toward foil 8 and are adapted to perforate foil 8. Most of the central perforation elements 13 are moreover each provided with three throughflow channels 15 extending from an upper side of perforation structure 10 to an underside of perforation structure 10 in order to enable discharge of water enriched with the substance, i.e. the prepared beverage, in capsule 1. As shown in FIG. 2, all perforation elements 12, 13 protrude equally far, whereby the outer ends of perforation elements 12, 13 form a virtual plane. In the shown initial situation foil 8 engages on substantially all perforation elements 12, 13, such however that foil 8 remains intact (closed). By breaking the connections 11 between support structure 9 and perforation structure 10 the perforation structure 10 can be displaced from an initial position (first position) to a higher position (second position) in which perforation structure 10 at least partially perforates foil 8, whereby the discharge side of capsule 1 is in fact opened, and wherein perforation structure 10 comes to lie at least partially in a space enclosed by housing 2. Breaking the connections 11 can be realized by a user him/herself, but will in practice generally be realized in the capsule holder during closing of the capsule holder, and thereby clamping of capsule 1.

During clamping of capsule 1 in the capsule holder the breakable connection between support structure 9 and perforation structure 10 will in practice generally be broken and perforation structure 10 will be pushed in the direction of foil 8, whereby the peripheral perforation elements 12 will pre-perforate foil 8 and the central perforation elements 13 will not perforate foil 8, or hardly so, because of the loss of foil tension resulting from the peripheral perforation (phase I). In a subsequent brewing process (preparation process) for preparing the beverage, water—and generally air—will be pressed into the capsule at a pressure of between 1 and 20 bar, whereby the peripherally perforated foil 8 is forced against the central perforation elements 13, whereby foil 8 will be further perforated (phase II). The assembly of perforated foil 8 and perforation structure 10 will act here as filter, wherein beverage will be allowed through and solid parts, in particular residue, will be held back.

During the clamping particularly engaging edge 9 of capsule 1 is clamped in order to realize a seal between capsule 1 and the capsule holder. It is advantageous here for upper part 9a of support structure 9 to be manufactured from a resilient material such as a TPO. A reliable seal of the capsule in the capsule holder is realized by the thermoplastic character of the material of upper part 9a of support structure 9. Other than conventional thermosetting elastomers (rubber elastomers), thermoplastic polymers are manufactured using equipment suitable for processing resins. Thermoplastic polymers are quicker and easier to manufacture than thermosetting elastomers, which are manufactured in three lengthy steps (mixing, injection moulding and cross-linking). Other than thermosetting polymers, thermoplastic polymers can moreover be fully or partially recycled. Since lower part 9b of support structure 9 is generally manufactured at least partially from PP and ultrasonic welding is recommended to mutually connect lower part 9b and upper part 9a, it is advantageous for a thermoplastic polypropylene-based elastomer to be applied, such as Adflex®, in particular Adflex® X500F.

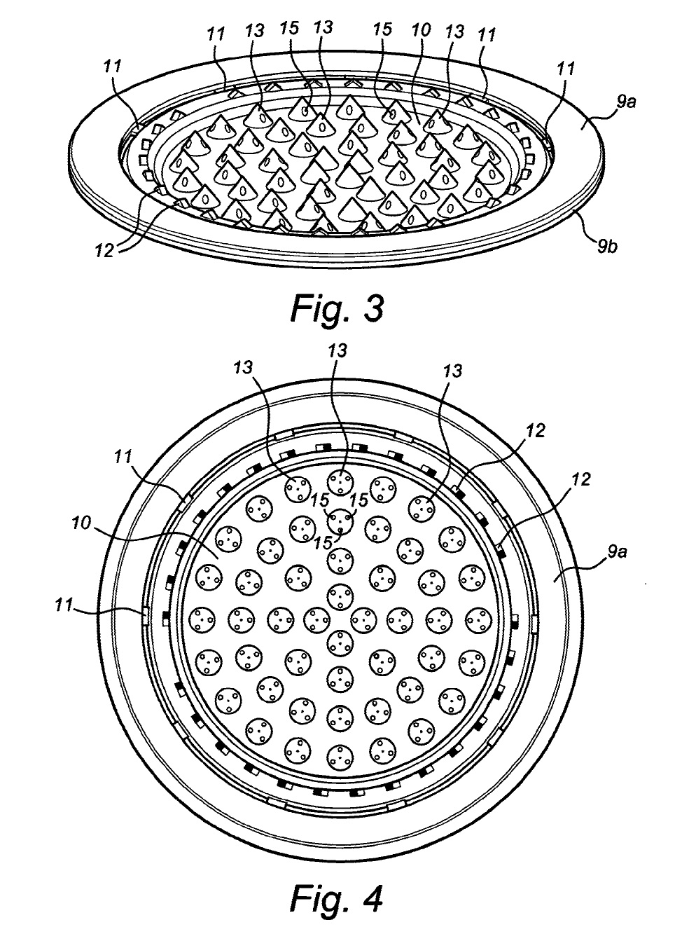

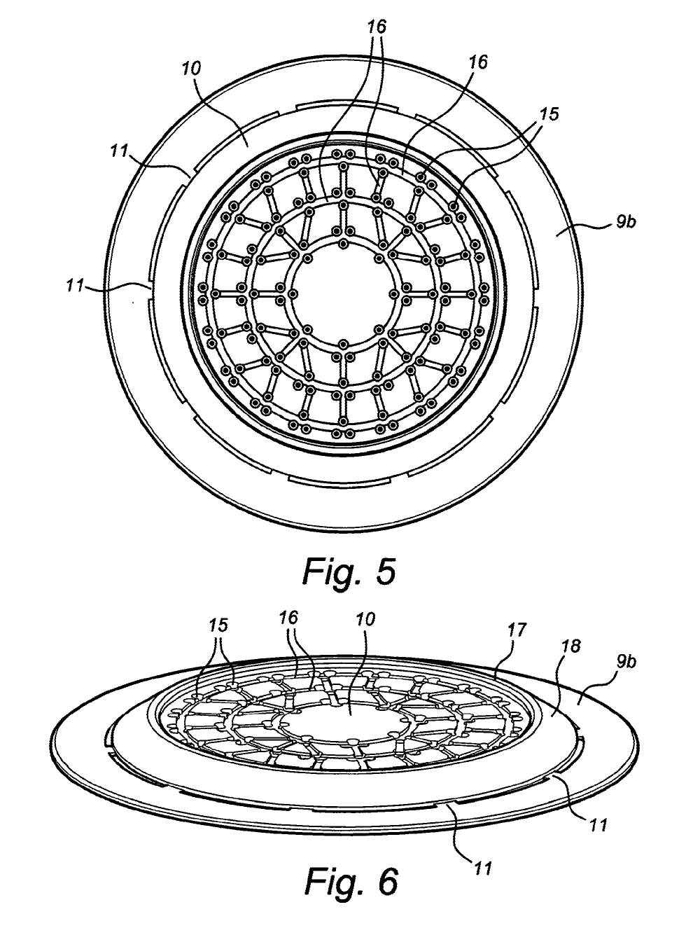

FIG. 3 is a perspective view and FIG. 4 is a top view of the assembly of support structure 9 and the perforation structure 10 releasably connected to support structure 9. Connecting elements 11 for initially connecting support structure 9 and perforation structure 10 decrease in thickness in the direction of perforation structure 10, whereby connecting elements 11 tend to break at the transition surface with perforation structure 10, whereby subsequent displacement of perforation structure 10 can proceed in relatively controlled manner. Also shown is that the central perforation elements 13 take a cone-shaped (conical) form, wherein the most centrally located perforation elements 13 are moreover not provided with throughflow channels 15. The most important reason for this is of a production engineering nature in that this facilitates manufacture of perforation structure 10 by means of injection moulding, this being elucidated in the bottom view of the assembly as shown in FIG. 5. Because the most centrally located perforation elements 13 are not provided with throughflow channels 15, a central free space is created which is advantageous for injection moulding and displacement of perforation structure 10. FIG. 5 further shows that the underside of perforation structure 10 is provided with a network of surface grooves 16 mutually connecting lower outer ends of throughflow channels 15, whereby sealing of throughflow channels 15 by the capsule holder, and thereby blockage of capsule 1, can be prevented. Further shown in the perspective bottom view of FIG. 6 is that perforation structure 10 is provided with an upright edge 17 adapted on the one hand for sealing connection to the capsule holder, in order to prevent leakage as far as possible, and on the other to make perforation structure 10 stackable (nestable) with another perforation structure 10, this being particularly advantageous from a production engineering viewpoint. FIGS. 1, 2 and 6 further show that the progression of upright edge 17 to peripheral edge 18—connected to connecting elements 11—of perforation structure 10 takes a chamfered form in order to facilitate handling of the capsule in the capsule holder. Instead of a plane chamfering, it is also possible to envisage this chamfering being given a curved form. The external diameter of peripheral edge 18 of perforation structure 10 will otherwise preferably be substantially equal to the largest internal diameter of housing 2, so that perforation structure 10 can be pushed with clamping fit into housing 2. A perforated foil part will usually be clamped here between housing 2 and perforation structure 10, this enhancing the edge sealing of capsule 1, whereby beverage will be discharged from capsule 1 substantially only via throughflow channels 15.

In the shown first embodiment of capsule 1 according to the invention the following product specifications can be applied. In the case a plastic housing 2 is applied, the wall thickness thereof can vary and be adapted to the functionality of the relevant part of housing 2. The thickness of flange 7 can for instance amount to between 0.30 and 0.6 5 mm, while the thickness of the upper wall amounts to 0.15 mm. A slight overpressure of 200 to 300 mbar is present in capsule 1 so that deformation of capsule 1 can be resisted prior to use, foil 8 can be pressed against perforation structure 10 and as much oxygen as possible driven out of capsule 1 during the production process. A typical height of the central perforation elements 13 amounts to between 1 and 2 mm, wherein the length of throughflow channels 15 preferably lies between 0.3 and 0.45 mm. The (narrowest) diameter of throughflow channels 15 amounts to between 0.7 and 0.9 mm. The width of connecting elements 11 amounts in this example to between 1 and 2 mm. The overall thickness of engaging edge 14 amounts to about 1.0 mm, wherein the thickness of flange 7 preferably lies between 0.3 and 0.4 mm, the thickness of foil 8 amounts to about 0.02 mm, the thickness of upper part 9a of support structure 9 amounts to about 0.3 mm and the thickness of lower part 9b of support structure 9 also amounts to about 0.3 mm. Applying the above stated dimensioning results in a capsule with a relatively large internal volume of between 14.2 and 14.6 cm³.

FIGS. 7 and 8 show cross-sections of a capsule 1 as according to FIGS. 1-6 in a capsule holder 19 of a device for preparing beverages such as a coffee machine, in an opened situation prior to use of capsule 1 (FIG. 7) and in a closed situation in which the beverage can be prepared (FIG. 8). Capsule holder 19 here comprises a first holder part 19a and a second holder part 19b displaceable relative to first holder part 19a. First holder part 19a comprises one or more cutting elements 20 for perforating upper wall 3 of capsule 1. First holder part 19a further comprises a clamping edge 21 for pressing engaging edge 14 onto second holder part 19b such that capsule holder 19 is substantially completely sealed, whereby leakage of water can be prevented. Second holder part 19b is provided with one or more discharge openings 22 for beverage. During closing of capsule holder 19 by displacing first holder part 19a and second holder part 19b toward each other the upper wall 3 of capsule 1 will be perforated, engaging edge 14 will be clamped substantially liquid-tightly between the two holder parts 19a, 19b and perforation structure 10 will moreover be pressed into housing 2, whereby foil 8 will be at least partially perforated and discharge of beverage from capsule 1 made possible. The advantage of this pre-perforation, among others, is that a better aeration of capsule 1 is obtained, this generally enhancing both the beverage preparation process and the finally obtained taste of the beverage. Foil 8 will be further perforated by the central perforation elements 13 during the beverage preparation process.

FIGS. 9a and 9b show cross sections of a second embodiment of a capsule 30 according to the invention. Capsule 30 comprises a housing 31 and a skirt 32 optionally connected integrally to housing 31 and provided with a protruding flange 33 adapted to enable clamping of capsule 30 in a capsule holder, and with an internal stop edge 34. An upper side 35 of skirt 32 is provided with a perforable foil (not shown). Capsule 30 also comprises perforation structure 36 which is linearly displaceable relative to skirt 32. The displacement is bounded here by two protruding flanges 37. Perforation structure 36 is provided on a side facing toward the foil with a plurality of pyramid-like perforation elements 38 between which throughflow channels 39 are arranged for discharge of beverage. In a lower position (first position) of perforation structure 36 the foil will completely seal the housing (FIG. 9a). When capsule 30 is clamped into the capsule holder, perforation structure 36 will be pressed to an upper position (second position), whereby the foil will be at least partially perforated.

FIG. 10 shows a cut-away perspective view of another capsule 55 according to the invention. Capsule 55 comprises a substantially truncated conical (frustoconical) housing 56 in which a substance for extraction is received (not shown). Housing 56 is provided with a laterally protruding edge 57. Edge 57 has the function (among others) of enabling clamping of capsule 55 in a device for preparing beverages. Edge 57 is also used to enable adhesion and/or welding of a foil 58 to housing 56. Capsule 55 further comprises an at least partially flexible piercing element 59 (perforation structure) arranged on a side of foil 58 remote from housing 56. A peripheral edge 60 of piercing element 59 is here also adhered and/or welded to edge 57, optionally with interposing of foil 58. Piercing element 59 comprises a plurality of piercing members 61 directed toward foil 58 and a plurality of throughfeed openings 62 for water. In the shown situation the foil is not pierced. By exerting a force on (a central part of) piercing element 59 in the direction of foil 58 the piercing element 59 will at least partially deform, whereby foil 58 will be perforated. The operation of capsule 55 is further shown in FIGS. 11a-11c, wherein FIG. 11a further shows that capsule 55 is positioned in the first instance close to a perforated plate 63 provided with throughflow channels 64, perforated plate 63 forming part of a device for preparing beverages. Capsule 55 and perforated plate 63 are then pressed against each other. This can for instance take place by pressing capsule 55 manually against perforated plate 63, but will generally rather take place in practice by mechanical clamping of capsule 55 between perforated plate 63 and a clamping element (not shown) enclosing capsule 55, wherein capsule 55 is engaged particularly on peripheral edge 57. The result of this pressing together is that piercing element 59 will deform (FIG. 11b) in the direction of foil 58 and will pierce foil 58. Piercing element 59 will here finally come to lie substantially parallel to perforated plate 63 (FIG. 11c). In this latter situation of capsule 55 an injection pin (not shown) will perforate a supply side of capsule 55, after which water is pressed via the injection pin into capsule 55. The water pressed into capsule 55 will subsequently be discharged via perforated foil 58, throughfeed openings 62 of piercing element 59 and throughflow channels 64 of perforated plate 63, after which the extract-enriched water, generally coffee, is collected in a drinking cup (not shown). FIG. 12 is a detailed perspective view of piercing element 59, which clearly shows that piercing element 59 takes a disc-like form. Piercing element 59 in fact comprises a stationary peripheral edge 65 and a deformable central part 66 connected pivotally to peripheral edge 65. The pivotable coupling between the stationary peripheral edge 65 and central part 66 is formed here by a film hinge 67.

It will be apparent that the invention is not limited to the exemplary embodiments shown and described here, but that within the scope of the appended claims numerous variants are possible which will be self-evident to the skilled person in the field.

1. A capsule for preparing beverages, comprising:
a housing at least partially filled with a substance to be extracted and/or dissolved, such as ground coffee, wherein the housing is provided with a supply side for guiding a liquid such as water into the capsule, and with a discharge side located a distance from the supply side for discharging liquid provided with extract and/or dissolved substance and guided through the capsule, wherein at least a part of the discharge side of the housing is initially sealed by a perforable foil;
a laterally protruding engaging edge connected to the housing to enable clamping of the capsule in a device for preparing beverages; and
a perforation structure coupled to the engaging edge and/or the housing and provided with at least one perforation element facing toward the foil, which perforation structure is positioned substantially on a side of the foil remote from the housing, which perforation structure is displaceable from a first position, in which the foil is substantially intact, to a second position in which the at least one perforation element perforates the foil, whereby discharge of liquid from the capsule is possible.

2. The capsule as claimed in claim 1, wherein the perforation structure is initially connected in the first position via at least one breakable connection to the engaging edge, wherein the perforation structure is displaceable to the second position by breaking the connection between the perforation structure and the engaging edge.

3. The capsule as claimed in claim 2, wherein the perforation structure is initially positioned such that the connection between the engaging edge and the perforation structure will be broken during clamping of the capsule in the device.

4. The capsule as claimed in claim 1, wherein the foil initially seals the housing substantially medium-tightly.

5. The capsule as claimed in claim 1, wherein the housing and the perforation structure are positioned on either side of a plane defined by the foil.

6. The capsule as claimed in claim 1, wherein the perforation structure is substantially enclosed by the housing in the second position.

7. The capsule as claimed in claim 1, wherein an inner side of the housing and an edge periphery of the perforation structure clamp a foil part in the second position.

8. The capsule as claimed in claim 1, wherein the perforation structure takes a substantially plate-like form.

9. The capsule as claimed in claim 1, wherein an edge periphery of the perforation structure is connected via at least one connecting element to the engaging edge.

10. The capsule as claimed in claim 9, wherein the thickness of the connecting element decreases in the direction of the perforation structure.

11. The capsule as claimed in claim 1, wherein the engaging edge comprises at least one flange connected integrally to the housing.

12. The capsule as claimed in claim 1, wherein the engaging edge has a laminated structure and comprises at least one flange connected to the housing and a support structure coupled to the flange, the support structure being adapted for co-action with the perforation structure.

13. The capsule as claimed in claim 12, wherein the support structure has a substantially annular shape.

14. The capsule as claimed in claim 12, wherein the support structure at least partially encloses the flange.

15. The capsule as claimed in claim 1, wherein at least a part of the engaging edge is manufactured from a resilient material, in particular an elastomer, more particularly a rubber elastomer.

16. The capsule as claimed in claim 15, wherein the resilient material comprises polypropylene.

17. The capsule as claimed in claim 15, wherein the resilient material is manufactured at least partially from a thermoplastic polyolefin (TPO).

18. The capsule as claimed in claim 17, wherein the thermoplastic polyolefin resilient material comprises a composition of polyolefins comprising polypropylene and an elastomeric copolymer, the copolymer comprising units of ethylene and units of an α-olefin.

19. The capsule as claimed in claim 18, wherein the α-olefin is formed by ethylene, propylene or 1-butene.

20. The capsule as claimed in claim 1, wherein an outer surface of the capsule is provided with at least one sealing element for sealing the capsule in the device.

21. The capsule as claimed in claim 1, wherein the perforation structure is provided with a plurality of throughflow channels for discharge of liquid, the throughflow channels extending from a side of the perforation structure facing toward the foil to a side of the perforation structure remote from the foil.

22. The capsule as claimed in claim 1, wherein the perforation structure is provided with a plurality of perforation elements.

23. The capsule as claimed in claim 21, wherein at least a number of throughflow channels are located at a distance from the perforation elements.

24. The capsule as claimed in claim 21, wherein at least one perforation element is provided with at least one throughflow channel.

25. The capsule as claimed in claim 20, wherein a side of the perforation structure remote from the foil is provided with at least one surface groove, the surface groove connecting to at least one outer end of at least one throughflow channel.

26. The capsule as claimed in claim 25, wherein a side of the perforation structure remote from the foil is provided with a plurality of surface grooves, the surface grooves connecting the outer ends of the throughflow channels to each other.

27. The capsule as claimed in claim 1, wherein at least a number of perforation elements take a pointed, in particular pyramid-shaped and/or cone-shaped form.

28. The capsule as claimed in claim 1, wherein an edge part of the perforation structure facing toward the foil is provided with at least one perforation element for realizing an edge perforation in the foil.

29. The capsule as claimed in claim 28, wherein peripherally oriented perforation elements are positioned closer to the foil in the first position than centrally oriented perforation elements.

30. The capsule as claimed in claim 1, wherein in the first position the foil engages under bias on at least one perforation element.

31. The capsule as claimed in claim 1, wherein a side of the perforation structure remote from the foil is provided with an upright sealing edge which protrudes in a direction away from the foil.

32. The capsule as claimed in claim 1, wherein a side of the perforation structure remote from the foil is provided with a chamfered peripheral edge.

33. The capsule as claimed in claim 1, wherein the capsule is assembled with a device for preparing beverages, which device comprises a capsule holder for receiving the capsule.

34. The assembly as claimed in claim 33, wherein the capsule holder comprises a plurality of holder parts which are mutually displaceable between an opened position, in which the capsule can be placed in the capsule holder, and a closed position in which the engaging edge of the capsule is clamped by the holder parts and the perforation structure is uncoupled from the engaging edge and is pressed at least partially into the housing while perforating the foil.

35-36. (canceled)

37. A method for preparing a beverage by making use of an assembly as claimed in claim 33, comprising of:
A) placing a capsule in at least a part of an opened capsule holder,
B) closing the capsule holder with clamping of the engaging edge of the capsule, wherein during step B) the perforation structure of the capsule is displaced from a first position, in which the foil is substantially intact, to a second position in which the at least one perforation element of the perforation structure perforates the foil, whereby discharge of liquid from the capsule is possible,
C) pressing liquid, in particular water, into the capsule via the supply side of the capsule, and
D) discharging via the perforated foil liquid guided through the capsule.

38. The method as claimed in claim 37, wherein during pressing of liquid through the capsule the foil is further perforated by at least one of the perforation elements forming part of the perforation structure.
